(19) United States
(12) Patent Application Publication
(10) Pub. No.: US 2001/0042000 A1
(43) Pub. Date: Nov. 15, 2001

(54) METHOD FOR MATCHING JOB CANDIDATES WITH EMPLOYERS

(76) Inventor: WILLIAM DEFOOR JR., KANSAS CITY, MO (US)

Correspondence Address: CHASE & YAKIMO, L.C., 4400 COLLEGE BLVD. SUITE 130, OVERLAND PARK, KS, 66211, US

(21) Appl. No.: 09/188,422

(22) Filed: Nov. 9, 1998

(51) Int. Cl. G06F 17/60

(52) U.S. Cl. 705/9

(57) ABSTRACT

A method of matching job candidates with jobs in a specific city or region includes the steps of creating an accessible database, such as an Internet web site, which is specifically representative of a city or region, and a particular career field, e.g. the career field might be Information Technologies and Services (“I/T” and “I/S”, respectively). Job candidates with skills or training in that career field who are interested in the specified city or region will come to the web site and post their qualifications in a specific skills matrix which incorporates very specific skill, competency and experience components. Employers can also enter positions in the same skills matrix format and operate a search engine which efficiently matches job position with candidate. As a result, job candidates can quickly and efficiently view all jobs available for their specific skills matrix in that city or region. Similarly, employers can quickly and efficiently identify candidates who fit the specific skills needed for a job since the available, qualified candidates have already evidenced an interest in locating in the city or region.

### BACKGROUND OF THE INVENTION

1. Field of The Invention

The present invention relates to a method for matching job candidates with employers, and, more particularly, to such a method in which job candidates and employers are directed to a city or area and career field specific database, such as an Internet web site. Once on-line to the database, each candidate enters his or her qualifications, and each employer enters his job requirements, in a specific job skills matrix format which allows efficient matching of qualified candidates and jobs.

2. Description of The Related Art

Employment search and recruiting firms have increasingly relied upon centralized databases, such as Internet web sites, to match job candidates with employers. One example of such a web site is “The Monster Board®”, which features jobs in a wide variety of specialties for employers world-wide. Other than its size and scope, the Monster Board® is typical of many job search web sites in that job candidates are urged to post their resume and employers can search through resumes or post jobs by description. A resume guide is provided with a number of selectable categories including location and general career field, as well as a number of text blocks with prompts such as “cover letter”; “Technical Skills”; “Non-Technical Skills”; “Job responsibilities”; “Previous Positions Held”; “Education”, etc. Potential employers are matched with candidate resumes by location and general career field and string text matching of job description and resume. This is a hit or miss proposition, at best.

With certain variations, this approach is fairly typical of most database employment search operators. However, this presents a problem for employers in relatively obscure or small markets, such as mid-sized Midwestern cities, for example, where few or even no matches may result from asking candidates for geographic preferences. Conversely, major employers on the population centers of the East and West Coasts can be presented with a bewildering array of candidate resumes in response to a resume/job word string match, with the majority of the candidates being unqualified.

It is clear, then, that a different method of matching job candidates with employers is needed. Such a method should efficiently match job openings with qualified candidates who are interested in locating in the employer's city, without inundating employers with resumes of unqualified or disinterested candidates.

### SUMMARY OF THE INVENTION

The present invention is directed to a method of matching job candidates with jobs in a specific city or region. The method includes the steps of creating an accessible database, such as an Internet web site, which is specifically representative of a city or region, and a particular career field. For example, the city might be greater Kansas City, Mo., and the career field might be Information Technologies and Services (“I/T” and “I/S”, respectively). Job candidates with skills or training in that career field who are interested in the specified city or region will come to the web site and post their qualifications in a skills matrix which incorporates very specific skill, competency and experience components. A candidate is led through to an exhaustive, and regularly updated, listing of skills and experience levels and is instructed to enter skills information for all that apply. Each skill in the listing includes a notes section for entering the particulars relating to that skill. Experience levels are selected from a number of categories. Employers can also enter positions in the same skills matrix format and operate a search engine which efficiently matches job position with candidate. As a result, job candidates can quickly and efficiently view all jobs available for their specific skills matrix in that city or region. Similarly, employers can quickly and efficiently identify candidates who fit the specific skills needed for a job since candidate/job matching is performed via the detailed skills matrix and since the available candidates have already evidenced an interest in locating in the city or region.

### OBJECTS AND ADVANTAGES OF THE INVENTION

The principle objects and advantages of the invention include: to provide an improved method of matching job candidates in a given career field with positions available in that career field in a given city or region; to provide such a method in which a detailed skills matrix resume is completed by each candidate, which skills matrix includes skills, competencies and experience levels; to provide such a method in which prospective employers can post job openings in a similar format and activate a search engine which efficiently matches qualified candidates with job openings; to provide such a method which increases the pool of available and qualified job candidates in a given city or region; to provide such a method which improves the communication between job candidates and prospective employers; to provide such a method in which generates a pool of critical information on candidates, job openings, salaries, etc. specific to a city or region; and to provide such a method which is particularly well suited for its intended purposes.

Other objects and advantages of this invention will become apparent from the following description taken in conjunction with the accompanying drawings wherein are set forth, by way of illustration and example, certain embodiments of this invention.

The drawings constitute a part of this specification and include exemplary embodiments of the present invention and illustrate various objects and features thereof.

### BRIEF DESCRIPTIONS OF THE DRAWINGS

FIG. 1 is a block diagram illustrating the inventive method of matching job candidates with prospective employers.

FIG. 2 is a block flow diagram representing activities of job candidates in entering resumes, building the requisite skills matrix and applying for a specific job.

FIG. 3 is a block flow diagram representing activities of “Charter Member” employers in searching for a job candidate.

FIG. 4 is a block flow diagram representing activities of “Regular Member” employers in searching for a job candidate.

### DETAILED DESCRIPTION OF THE INVENTION

As required, detailed embodiments of the present invention are disclosed herein; however, it is to be understood that the disclosed embodiments are merely exemplary of the invention, which may be embodied in various forms. Therefore, specific details disclosed herein are not to be interpreted as limiting, but merely as a basis for the claims and as a representative basis for teaching one skilled in the art to variously employ the present invention in virtually any appropriate manner.

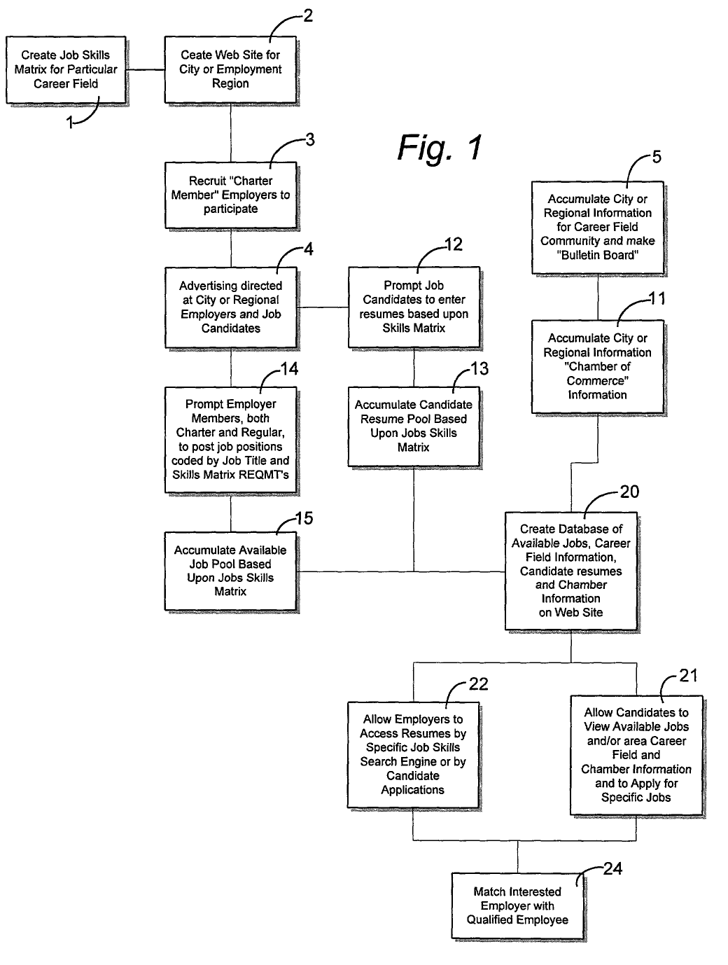

Referring to the drawing figures, FIG. 1 is a general block diagram generally indicating the steps of creating a web site based job and candidate match method according to the present invention. In block 1, a job skills matrix is created for a particular career field. The job skills matrix preferably includes specific selections for Experience Level, Competency Level, and Job Skills for the particular career field. For example, in a preferred embodiment in which information technology (“I/T”) and information services (“I/S”) are the career field, Experience Level was divided into four categories from novice to over 10 years; Competency Level was divided into five categories from beginner to expert; and Job Skills were divided into 176 different categories. Thus, the skills matrix allows for 20 different levels for each Job Skill, and with the 176 Job Skills categories, over 3500 different combinations can be plugged in. Jobs are also assigned Job Titles, and, initially, in the I/S & I/T fields, there are 27 different job titles.

At block 2, a web site is created, preferably with an address directed to a specific city or geographic region. At block 3, a number of “Charter Members” will be recruited, with each Charter Member agreeing to post an up front fee to fund start up and advertising costs for the web site provider in implementing the inventive matching method. At block 4, advertising directed to employers and potential job candidates located in, or amenable to relocating in, that particular city or region. In parallel with these steps, at block 5, a Bulletin Board of Career Field information is collected for posting on the web site, such as educational and professional organizations, social organizations, trends, and other information of interest to persons in the Career Field in that city or region. At block 11, a separate database of “Chamber of Commerce” type information is collected for posting on the web site for the purpose of attracting potential job candidates who might be interested in relocating to the region.

At block 12, job candidates are attracted to the web site and invited to enter a resume by entering their competency, experience and skills information for any and all pertinent skills. A notes section is also provided for entering descriptive information clarifying a skill, experience or competency. During the resume entry process, job candidates can place a “Do Not View” limitation such that certain employers will not be able to access their resume information. At block 13, a resume pool is collected from these job candidates, with each resume in the pool including the Skills Matrix information. At block 14, Charter Members and additional “Regular Members” post available jobs by Job Title and Skills Matrix skills set, and, at block 15, a database of available jobs, also categorized by the Skills Matrix, as well as by jobs title, is accumulated from those participating employers, both Charter and Regular Members. At block 20, a cumulative database is created including the candidate resumes, job pool, Career Field Bulletin Board and Chamber of Commerce type information. At block 21, job candidates can access available jobs by Skills Matrix search and can also access the other database information, except for the resume pool and employer information. At block 22, participating employers, either Charter or Regular Members, can review the pool of potential qualified job candidates by the use of a search engine driven by skills matrix entries and can also review a list of those employees who have specifically applied for one or more of their posted positions. At block 24, Employers are matched with prospective, qualified employees interested in, or qualified for their position, as will be explained in greater detail below.

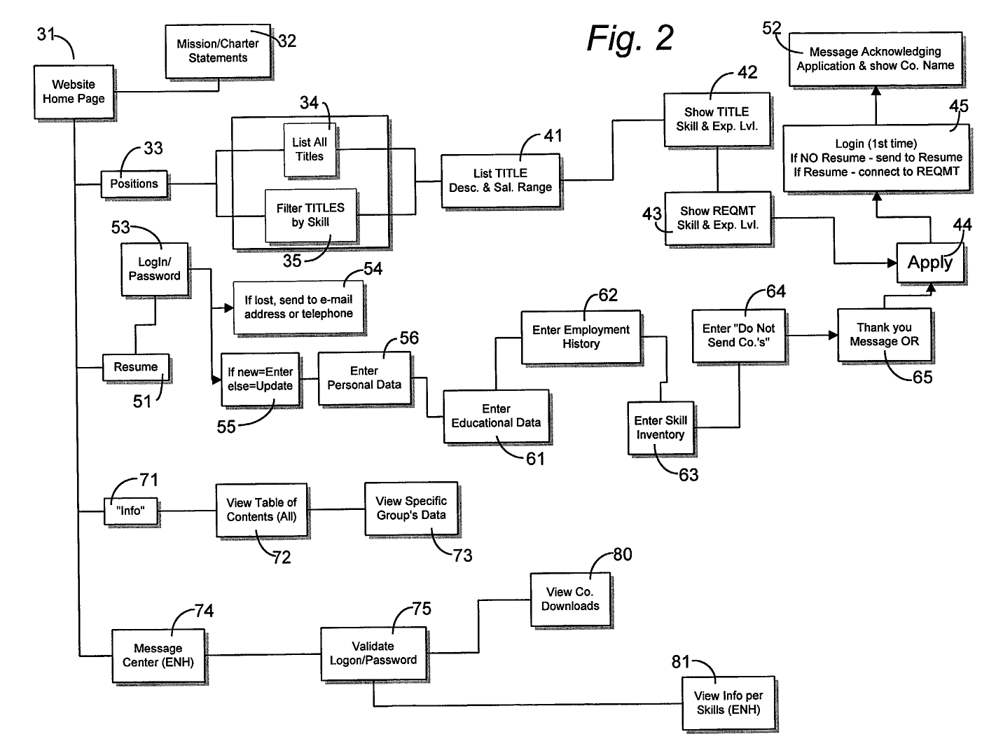

FIG. 2 illustrates a block diagram of options and available to a job candidate who visits the web site. At block 31, the web site is accessed, and a mission/charter page is available at block 32. Block 33 is a positions option by which a job candidate can review available job positions, either by selecting option 34 to view all of them according to specific job groupings or by exercising option 35 to filter the positions by Skill. A candidate can enter up to 3 job skills to filter the positions. At block 41, the Title, description and salary range for each position is displayed, with no Employer information. At block 42, a candidate can selectively view the Skill and experience level description for each position in which he or she is interested and, at block 43, the Skill and experience requirements for those positions can be viewed to clarify specific skill needs for the job description. At block 44, provided the candidate has found one or more positions in which he or she is interested, an “I'd Like to Apply” option is provided in which a candidate believes that he or she is qualified for a particular position and the candidate's interest and resume (must be on file to apply) will be forwarded to the employer. Once the candidate actually applies for a posted job position, they are notified, for the first time, which employer has posted that position. This is done to prevent a job candidate from prematurely “filtering out” those employers which they might have a built-in bias or prejudice against, other than those which have been labeled as “Do Not Send”, as described below.

At block 45, if the job candidate is a first time log-on, he or she is routed to the resume option block 51, which will be described below. Conversely, if a resume is already on file for that candidate, at block 52, a message is created acknowledging the application and showing the Employer's name.

Block 51, as mentioned above, is a resume entry option upon initial log-in or a candidate is directed there if a job application is wanted. At block 53, a Log-in/Password is assigned or requested if already assigned and, if lost, at block 54, the candidate is directed to call or E-mail the service provider. At block 55, if the candidate is a first time log-on, a “new” option is provided, or, if already registered, and update option is provided. At block 56, personal data, i.e. name, address, phone and e-mail numbers, etc. is requested, at block 61, educational information is requested, at block 62, employment history is requested, and, at block 63, the candidate fills out the Job Skills survey including Experience Level, Competency Level and Job Skill or Skills. At block 64, the candidate is requested to screen out any companies which they do not want to be made aware of their availability, e.g. present or past employers might be excluded here. At block 65, a Thank you message is generated and, if the candidate has been routed to the resume path from block 45, the application process is entered, as described above.

Block 71 represents another path option for a candidate accessing the web site in which the candidate can access other information such as the Chamber of Commerce type information or the Career Bulletin Board. A contents block 72 allows interactive selection of the options which they want to view and, at block 73, the specific information which they select is displayed.

Block 74 represents a message center enhancement path option for a candidate logging onto the system, in which a validated registered job candidate (block 75) can view Company downloads of their resume (block 80) to track the interest generated thereby. Alternatively, at block 81, the candidate can review job postings categorized by specific Skills and titles from the Job Skills matrix, without accessing specific employer information for the reasons explained above.

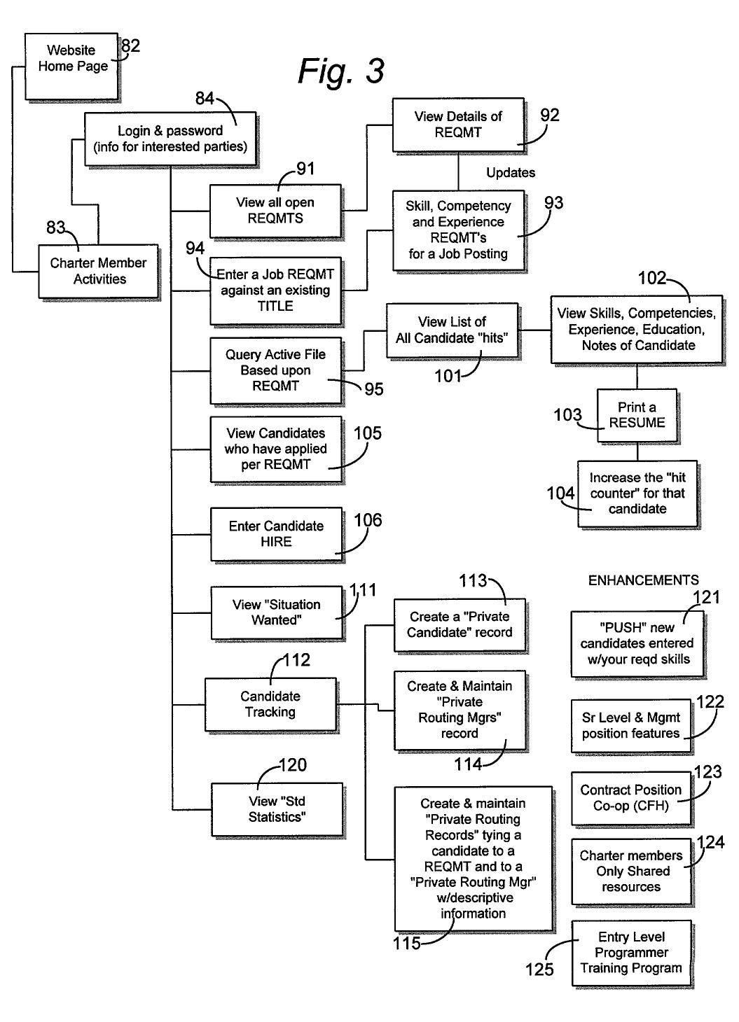

FIG. 3 illustrates a block diagram of options and paths available to a Charter Member employer who visits the web site. At block 82, the web site is accessed, and, at block 83, a listing of Charter Member activities is available. At block 84, the Charter Member employer is instructed to enter a login code and password or to access information if they are not registered. From the log-in block 84, a number of different path options are available to a registered Charter Member employer. At block 91, the Charter Member employer can view all of their open positions and the Requirements for those positions which they have previously listed. At block 92, the details of any Requirement can be reviewed, if desired, and these requirements can be updated or changed, at block 93, if needed. Another path is represented at block 94, where a Charter Member employer can post a new job opening against an existing job description title with, again at block 93, associated job Requirements based upon the Job Skills index. It should be noted that the Skills Index information can be entered as “Required” for that position or simply “Nice to Have”.

At block 95, another path option is represented in which the Charter Member employer can query the entire list of registered job candidates using a search engine based upon job Requirements, i.e. the Job Skills index. The search engines operate only on a Skills Requirement basis, i.e. they ignore the “Nice to Have” Skills entered for that position. These can be used by the Charter Member to further filter candidate “hits” for that position. At block 101, they can review all candidates which are “hit” by the search and, at block 102, the Job Skills index information for those candidates. At block 103, one or more candidate resumes can be printed, which will reveal the personal information for those candidates for the first time. A fee is charged for each resume viewed, and, at block 104, that candidate's “hit counter” is incremented. At block 105, all candidates who have applied for positions posted by the Charter Member can be accessed, per the job position Requirements.

At block 106, a Hire candidate entry is made, for which a charge is generated based upon a percentage of job salary. At block 111, a listing of “Situation Wanted” entries can be reviewed. These are posted by those job candidates who have not found any job postings suitable for their particular skills set or desire, e.g. upper level management positions which would not generally be posted using the normal Skills matrix. A job candidate basically posts his or her desired position description via this format and a Charter Member can review those position descriptions here.

At block 112, a private and proprietary “Candidate Tracking” path accessible only by that Charter Member can be entered in which, at block 113, a private Candidate record, (i.e. a candidate not discovered through the web site search) can be created. At block 114, a private Routing Managers record is created, i.e. a record of which company official or officials need to be routed with a particular job candidate's resumes and information. At block 115, a “Private Routing Record” is created which ties a particular candidate to a job posting via the Required Skills set and adds descriptive comments and other descriptive information generated during the routing of that candidate's resume to each of the managers in the “Private Routing Manager”. Again, each of the blocks 112-115 are proprietary to that Charter Member and are accessible only by that Charter Member.

Block 120 represents another path option available to Charter Members in which “standard Statistics” are available for review. These statistics are those generated from the experience of the web site provider, e.g. average salaries for Cobol programmers in that city or region with 4-5 years of experience. This type of statistic was previously available to employers only by costly independent survey firms or from the limited experience of that employer and its employees and managers.

Blocks 121-125 represent possible system enhancements which can be made available to all Registered Members in varying degrees, or only to Charter Members, as desired. At block 121, new job candidates with certain skills sets can be “pushed” toward Charter Member employers, i.e. a database for that Charter Member can be created by the web site provider in which certain job postings are immediately matched with new job candidates without requiring the employer to access them or query the candidate database. Also, Charter Members can be notified of the availability of candidates with certain skills sets regardless whether there are current job postings from that employer.

At block 122, different features for Senior Level and Management positions can be created, e.g. similar to the “Situation Wanted” service. Alternatively, special Skills Matrix sets can be created for this type of job candidate. At block 123, Contract Position cooperatives or “Contract for Hire” positions can be posted by Charter Member employers in which they are offering certain employees to other Charter Members on a contract basis. At block 124, Charter Member employers can share employee resources without compensation, e.g. employees with certain skills sets can be swapped for a limited time to enable completion of special projects. Finally, at block 125, in order to fill gaps in the availability of job candidates with certain Skills sets, an entry level Programmer Training program can be implemented by the web site provider so that pools of potential entry level employees can be created as a service to Charter Member employers.

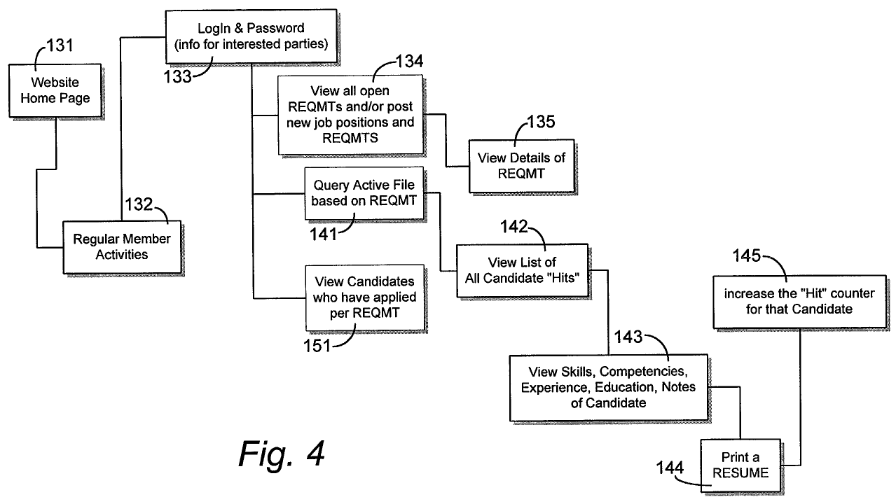

FIG. 4 is a block diagram illustrating the options and paths available to a regular employer (non-Charter Member) accessing the web site, as indicated at block 131. These are basically a sub-set of those options available to a Charter Member employer, as explained above with respect to FIG. 3. Block 132 represents a listing of Regular Member activities which can be reviewed. At block 133, the Regular Member employer is instructed to enter a login code and password or to access information if they are not registered. From the log-in block 133, a number of different path options are available to a registered Regular Member employer. At blocks 134 and 135, the Regular Member employer can view all of their open jobs and associated Requirements, post new jobs and Requirements and update those job postings and requirements as explained above with regard to blocks 91-94. At block 141, a Regular Member employer can query the entire list of job candidates using a search engine based upon job Requirements, i.e. the Job Skills index, as explained above with regard to block 95. At block 142, they can review all candidates which are “hit” by the search and, at block 143, the Job Skills index information for those candidates. At block 144, one or more candidate resumes can be printed, which, again, will reveal the personal information for those candidates for the first time. A fee is charged for each resume viewed, and, at block 145, that candidate's “hit counter” is incremented.

At block 151, a Regular Member employer can review all job candidates who have applied for one of their positions.

In one embodiment of the invention, specifically for information technology and information services positions, the following listing of skills was used: ABAP; Abend-Aid; MSAceess; Accelertr; ADABase; ADA; Amdahl; Analytical Skills; AS400; Assembler; C++; C; Case; CICS; Clipper; CLIST (tso); COBOL; COBOL II; Cobol-MicroFocus; Communication; Composer; Crystal Reports; DB/2; DB/3; Dbase IV; Datacom; DEC; Delphi; Dtaflex; DL/1; Data Modeling; MS Dos; Data Warehousing; DYL-280; Easel; EDI; Endevor; Erwin; EZ-Trieve; File Aid; File-Net; Focus; Focus-PC; Fortran; FoxBASE; FoxPro; Gupta; H/P; HTML; IBM PC & Com; IBM Series 2; IOCase; Ideal; IDMS; IEF code genre; IEW; IMS; Informix; Ingress; ISPF; JAVA; JCL; JES; Key for Enterprise; Knowledge War; LAN; Librarian; MAC; Mantis; Mapper; Misc. Skills; Multimate; Motif; MS Mail; MS Project; MS Exchange; Mumps; OS/MVS; OS/MVS.XA; Natural; NCR; Nomad; Novell; Other MainFrame; Other PC; Oracle; Oracle Forms; Oracle Reports; Oracle Case; OS/2; Paradox; Pascal/Turbo Pascal; Pathway; PeopleSoft; People Code; People Tools; PICK; PL/1; Project Mgmt; Powerbuilder; Quattro/Quattro Pro; Rbase; RDB; REXX; Roscoe; RPG II; RPG III; RPG IV; RS6000; SAP; SAS; Smalltalk; Smart; SQL-Server; SUN; Supra; Sybase-SQL; Syncsort; SYS 32, 34, 36; SYS38; Tandem; TCP/IP; TSO; TUXEDO; Unisys; Unix; Visual Basic; Visual C++; VMS; VSAM; Dos/Vse.Vm; WAN; Watcom; Windows NT; Windows 9x; MS Word; Workten; Xpediter; ZEKE; SQL; Relational Database Concepts; Query Tools; Metadata Configuration; Extraction and Transformation Utilities; Network Design; VTAm; SNA; Ethernet; Team Work (Soft Skills) Project Management; Consulting Skills; Internet Browser; Internet/Intranet; Firewall Technology; Encryption Technology; COOL:Biz; AutoTester; COOL;Gen; Systems Integration; Testing; GIF Files; Adobe Acrobat; Perl; JAVA Scritp; MVS; Cognos; BRIO; Business Objects; Process Modeling; Facilitation—Business Process Dev; Negotiation Skills; Systems Integration; MS Office; Korn Shell Scripts; Tivoli; and Active Server Pages.

In that same embodiment, the following I/T and I/S job titles were used: Administrative Support; DBA—Client Server; DBA—Mainframe; DBA—Oracle; Developer—Client Server; Developer—Mainframe; Developer—Web; Development Tool Specialist; Emerging Technologies Specialist; Help Desk; Project Management; SAP Specialist; Web Architect; Data Warehouse/Architect; Technical Architect; Enterprise Mgmt Tool Adm/Specialist; Application Administrator; Network Administrator/Specialist; and Business Analyst/Testing Coordinator.

These lists are considered to be exemplary only and are not to be considered limiting. Of course, the lists will be added to and subtracted from as the technology and software development change.

The claims are intended to apply broadly to any career field which is adaptable to the Job Skills indexing technique, including in addition to I/T and I/S positions, without limitation, the medical field, engineering, accounting, legal professions, etc. Thus, it is thus to be understood that while certain forms of the present invention have been illustrated and described herein, it is not to be limited to the specific forms or arrangement of steps described and shown.

What is claimed and desired to be secured by Letters Patent is as follows:

1. A method of matching qualified job candidates in a career field with employers who have job openings in that career field, comprising the steps of:
(a) creating a comprehensive Skills Matrix for that career field which includes a listing of Job Skills, Experience Levels and Competency Levels;
(b) prompting job candidates to enter their resumes based upon the comprehensive Skills Matrix;
(c) creating a database of job candidate resumes, each with entries corresponding to the comprehensive Skills Matrix;
(d) prompting employers to post job positions based upon the comprehensive Skills Matrix;
(e) creating a database of posted job openings, each with entries corresponding to the comprehensive Skills Matrix; and
(f) matching qualified job candidates with posted job openings based upon a match between the Skills Matrix entries in the job candidates resume and the Skills Matrix entries for that job posting.

2. A method as in claim 1, and further comprising the steps of:
(a) creating an Internet web site which is accessible to both job candidates and employers; and
(b) posting said databases on said Internet web site and prompting said job candidate and employer entries via said Internet web site.

3. A method as in claim 2, where said databases are for a specific geographic area, such as a city and surrounding suburbs and said Internet web site is identified with that specific geographic area.

4. A method as in claim 3, and further comprising the steps of:
(a) creating a database comprising “Chamber of Commerce” type information for that geographic region; and
(b) posting the Chamber of Commerce information on said Internet web site such that it is accessible to prospective job candidates.

5. A method as in claim 3, and further comprising the steps of:
(a) creating a database comprising career field Bulletin Board information for that geographic region; and
(b) posting the Bulletin Board information on said Internet web site such that it is accessible to prospective job candidates.

6. A method as in claim 3, wherein said career field is Information Technologies & Information Services (I/T and I/S, respectively), and said Skills Matrix creating step comprises creating over 100 different skills which apply to the I/T and/or I/S career fields.

7. A method as in claim 6, and further comprising the step of creating a plurality of job titles which can be used for entry of job postings and Skills Matrix information by employers.

8. A method as in claim 3, and further comprising the steps of:
(a) dividing the employers using the Internet web site into “Charter Member” employers and “Regular Member” employers; and
(b) providing enhanced services to the Charter Member employers.

9. A method as in claim 1, wherein said matching step includes the step of:
(a) allowing job candidates to review posted jobs matching their particular Skills Matrix qualifications;
(b) allowing those candidates to apply for any jobs for which they are qualified; and
(c) forwarding those applications, along with those candidates' resumes, to the employer(s) who have posted the job or jobs applied for.

10. A method as in claim 1, wherein said matching step includes the step of:
(a) allowing employers to search for job candidates by using a search engine which limits candidate “hits” by job requirements as represented by the posted required Skills Matrix qualifications; and
(b) allowing those employers to review the resumes of any qualified candidates in which they are interested.

11. A method of matching qualified job candidates in a career field with employers who have job openings in that career field in a particular geographic region, such as a city and surrounding suburbs, comprising the steps of:
(a) creating an Internet web site which is accessible to both job candidates and employers, with the Internet web site having some identification with the particular geographic region;
(b) creating a comprehensive Skills Matrix for that career field which includes a listing of Job Skills, Experience Levels and Competency Levels;
(c) prompting job candidates, via said Internet web site, to enter their resumes based upon the comprehensive Skills Matrix;
(d) creating a database of job candidate resumes, each with entries corresponding to the comprehensive Skills Matrix;
(e) prompting employers, via said Internet web site, to post job positions based upon the comprehensive Skills Matrix;
(f) creating a database of posted job openings, each with entries corresponding to the comprehensive Skills Matrix;
(g) posting said databases on said Internet web site; and
(h) matching qualified job candidates with posted job openings based upon a match between the Skills Matrix entries in the job candidates resume and the Skills Matrix entries for that job posting.

12. A method as in claim 11, and further comprising the steps of:
(a) creating a database comprising “Chamber of Commerce” type information for that geographic region; and
(b) posting the Chamber of Commerce information on said Internet web site such that it is accessible to prospective job candidates.

13. A method as in claim 11, and further comprising the steps of:
(a) creating a database comprising career field Bulletin Board information for that geographic region; and
(b) posting the Bulletin Board information on said Internet web site such that it is accessible to prospective job candidates.

14. A method as in claim 11, wherein said career field is Information Technologies & Information Services (I/T and I/S, respectively), and said Skills Matrix creating step comprises creating over 100 different skills which apply to the I/T and/or I/S career fields.

15. A method as in claim 14, and further comprising the step of creating a plurality of job titles which can be used for entry of job postings and Skills Matrix information by employers.

16. A method as in claim 11, and further comprising the steps of:
(a) dividing the employers using the Internet web site into “Charter Member” employers and “Regular Member” employers; and
(b) providing enhanced services to the Charter Member employers.

17. A method as in claim 11, wherein said matching step includes the step of:
(a) allowing job candidates to review posted jobs matching their particular Skills Matrix qualifications;
(b) allowing those candidates to apply for any jobs for which they are qualified; and
(c) forwarding those applications, along with those candidates' resumes, to the employer(s) who have posted the job or jobs applied for.

18. A method as in claim 11, wherein said matching step includes the step of:
(a) allowing employers to search for job candidates by using a search engine which limits candidate “hits” by job requirements as represented by the posted required Skills Matrix qualifications;
(b) allowing those employers to review the resumes of any qualified candidates in which they are interested.
